(19) United States
(12) Patent Application Publication
(10) Pub. No.: US 2008/0136100 A1
(43) Pub. Date: Jun. 12, 2008

(54) BOARD GAME

(76) Inventor: Kenneth JORGENSEN, Gentofte (DK)

Correspondence Address: STITES & HARBISON PLLC, 1199 NORTH FAIRFAX STREET, SUITE 900, ALEXANDRIA, VA, 22314, US

(21) Appl. No.: 11/867,950

(22) Filed: Oct. 5, 2007

(30) Foreign Application Priority Data
Oct. 16, 2006 (EP) 06 021608.2

(51) Int. Cl. A63F 3/02; A63F 3/00; A63F 13/12; A63F 9/24

(52) U.S. Cl. 273/241; 273/261; 463/42; 463/14

(57) ABSTRACT

The invention relates to a game apparatus and a corresponding method, where the game apparatus comprises a game board (1, 4) comprising a plurality of rows (R) and a plurality of columns (CO), said rows and columns defining fields (2) on said game board (1, 4), and a plurality of playing pieces (6, 7, 8, 9, 10, 11, 12), one set of playing pieces for each individual player of said game and furthermore a plurality of 3D-members (9) for providing different three-dimensional structures or landscapes on said game board (1, 4), the 3D-members (9) comprising a bottom face (32) for placement on said board or on an adjacent 3D-member, a top surface (22, 31) for placement of an adjacent 3D-member or one of said playing pieces (6, 7, 8, 9, 10, 11, 12) and side faces (30), where the side faces (30) during a play can represent fields (2) that according to specified rules of the game are able to affect permitted movements of said playing pieces (6, 7, 8, 9, 10, 11, 12). At least one purpose of the invention is to provide a board game where the traditional flat game board can be extended to a three-dimensional structure, which structure actively affects the movement of the playing pieces, thereby increasing the challenge of the play.

### TECHNICAL FIELD

The invention relates generally to-board-type games and more specifically to games comprising a board subdivided into a pattern of rows and columns of the kind for instance known from traditional chess or checkers and even more specifically to games, where the surface of the game board can be modified in order to attain a three-dimensional structure of the board, such that this structure can play an active role in the play according to a set of predefined rules of the play.

### BACKGROUND OF THE INVENTION

Traditionally board games, such as chess or checkers, are played using a two-dimensional board. However some board games comprising a three-dimensional board structure are known within the art.

Thus, U.S. Pat. No. 3,871,657 discloses a multi-level chess or checkerboard comprising a number of blocks for placement on the fields of the board itself, whereby a three-dimensional pattern of blocks can be provided on the flat board. Using this board, either chess or checkers is played in the traditional manner, i.e. after the traditional rules for chess or checker, respectively, the pattern of blocks merely serving the purpose of increasing the conceptual difficulties of these games. The blocks themselves according to this document serve no active purpose in the game.

Furthermore, DE 91 01 839 discloses a chessboard in the form of either a fixed or variable three-dimensional structure. How this structure is actually used during a game is not described in this document.

The above three-dimensional structures of the game board are used to increase the perceptual difficulty of challenge of the game, but the potential of three-dimensional structure for actually varying the game, for instance under the influence of the different players, has not been exploited in these board games. It would be advantageous to provide a board game in which the strategy of the game could be varied either under the control of the individual players or based on chance and where the three-dimensional structure itself would influence the progress of a given game. Also, it would be advantageous as an option to provide a game of this kind, which would not necessarily be limited to the two players of conventional chess or checkers.

### SUMMARY OF THE INVENTION

On the above background it is an object of the present invention to provide a board game in which a three-dimensional structure can be built up either before the commencement of the board game as such or additionally or alternatively during the progress of the board game.

It is a further object of the present invention to provide a board game, where said three-dimensional structure can play an active part in the game according to predefined rules of the game.

It is a further object of the present invention to provide a board game of said kind comprising sets of playing pieces of a different kind than those traditionally used in chess or checkers.

It is a further object of the present invention to provide a board game of said kind in which more than two players can participate.

The above and other objects and advantages are attained according to the present invention by a board game (and a corresponding method of playing a game using the board and additional members of the board game), where said board game comprises a two-dimensional game board subdivided into a number of rows and columns, thus forming a number of individual fields. Adjacent fields may be provided with different colours to better distinguish adjacent field from another, in principle in the traditional manner of chess or checkers. As in chess the columns may be designated by a set of letters, for instance A, B, C . . . and the rows by a set of numbers, for instance 1, 2, 3 . . . .

The board game according to the invention furthermore comprises a number of 3D-members (three-dimensional members or obstacles or support structures) for constructing the three-dimensional structure of the game board according to different rules of the game. In case of said fields of the two-dimensional board being square, said members could be formed as blocks, for instance square blocks, but they may in fact be formed in any manner appropriate for the lay-out of the game board. In the detailed description of the invention, specific embodiments of game boards and said 3D-members are shown, but these embodiments are only to be regarded as exemplifying the basic concept of the invention.

Thus, according to the invention there is provided a game apparatus for playing a game, comprising
a game board comprising a plurality of rows (R) and a plurality of columns (CO), said rows and columns defining fields on said game board;
a plurality of playing pieces, one set of playing pieces for each individual player of said game;
a plurality of 3D-members for providing different three-dimensional structures or landscapes on said game board, the 3D-members comprising a bottom face for placement on said board or on an adjacent 3D-member, a top surface for placement of an adjacent 3D-member or one of said playing pieces and a plurality of side faces;
   where said side faces during a play represent fields that according to specified rules of the game are able to affect permitted movements of said playing pieces.

Thus, according to the invention, said 3D-members can function as obstacles determining permitted movements of the playing pieces as well as support structures, upon which playing pieces may be placed as the game progresses.

According to a specific and presently preferred embodiment of the invention, the height of the said 3D-members corresponds to the dimension of each of the fields on the two-dimensional board. Thus, according to this embodiment, a given vertical face (side face) of a 3D-member corresponds to a field on the two-dimensional board and is regarded as a field during the game. Specifically according to this embodiment, the vertical faces of a given 3D-member (block) is regarded as a field of the game board, thereby affecting the actually permitted movements of the playing pieces on and in the vicinity of the 3D-member. Furthermore, according to the invention, a plurality of 3D-members may be placed adjacent each other or on top of each other, thereby forming different kinds of more complicated three-dimensional structures or landscapes on the basic two-dimensional board. Thus, the top surfaces of the uppermost 3D-members can be provided at different vertical levels above the ground level of the board itself. Examples of the manner in which different groups of 3D-members can be constructed and thereby affect the permitted movements of playing pieces will be given in the detailed description of the invention.

It would alternatively according to the invention be possible to apply for instance blocks as mentioned above but with a vertical dimension less than the edge of the fields on the board and then either prior to or during a play stack more blocks on top of each outer to obtain a complete vertical field, the dimensions of which would correspond to the dimensions of the fields on the board.

According to a specific embodiment of the board game according to the invention, a game comprises basically two phases: (1) An initial phase with the purpose of choosing a given scenario (placement of 3D-members on the board), and (2) the board game itself, where the playing pieces are moved through the “landscape” created by the game board and the 3D-members placed on this in the initial phase of the game. Various such scenarios are described in the detailed description of the invention. According to the embodiments of the game described in the detailed description of the invention, phase 1 is performed as a card game, but other possibilities of course exist and would also fall within the scope of the invention.

According to the invention there is furthermore provided a method for playing a board game, comprising the following steps:
providing a game board, comprising a plurality of rows (R) and a plurality of columns (CO), said rows and columns defining fields on said game board;
providing a plurality of playing pieces, one set of playing pieces for each individual player of said game;
providing a plurality of 3D-members for providing different three-dimensional structures or landscapes on said game board, the 3D-members comprising a bottom face for placement on said board or on an adjacent 3D-member, a top surface for placement of an adjacent 3D-member or one of said playing pieces and side faces, where said side faces during a play can represent fields that according to specified rules of the game are able to affect permitted movements of said playing pieces;
in a first phase of the game choosing between different types of game to be played, where at least one of said types of game requires the placement of said 3D-members on chosen fields of the game board or on top of other of said 3D-members;
if required according to the type of game chosen, placement of the 3D-members on the game board;
performing a board game using said playing pieces and thereby moving said pieces on the board according to predefined rules of the game and under influence of 3D-members placed on the board.

According to specific rules of the game, said 3D-members could additionally and supplementarily act as playing pieces, whereby for instance a given 3D-member may attack and capture one of the opponents' playing pieces.

Although the present invention in the following detailed description of the invention will be described in the form of a physical game board and associated playing pieces and 3D-members etc., it is understood that the present invention also encompasses electronic versions of the game, stored on an appropriate electronic storage medium (a hard disk, DVD, etc.). Such electronic versions of the game can according to the invention be loaded into a PC and the game performed locally from this PC using appropriate user interface means to control screen images of the game. Electronic versions of the game can also according to the invention be used remotely, for instance by storing electronic versions of the game on appropriate storage means and displaying and controlling the game remotely via a suitable electronic communication network, such as the Internet.

### BRIEF DESCRIPTION OF THE DRAWINGS

The invention will be better understood with reference to the following detailed description of embodiments of the invention in conjunction with the figures, where:

FIG. 1 shows a first embodiment of a game board according to the invention;

FIG. 2 shows a second embodiment of a game board according to the invention;

FIG. 3 shows an embodiment of playing pieces according to the invention;

FIG. 4 shows the first embodiment of the game board of the invention with playing pieces in their initial positions on the board;

FIG. 5 shows the second embodiment of the game board of the invention with playing pieces in their initial positions on the board;

FIGS. 6 (a)-(g) show permitted movements of the playing pieces according to an embodiment of the invention;

FIG. 7 shows a first pattern of elements used to form a first three-dimensional scenario (termed “Game of Sergeant”) on the board;

FIG. 7(a) shows a specific embodiment of a 3D-member according to the invention in the form of a square;

FIG. 8 shows a second pattern of elements used to form a second three-dimensional scenario (termed “Game of Observer”) on the board;

FIG. 9 shows a third pattern of elements used to form a third three-dimensional scenario (termed “Game of Spy”) on the board;

FIG. 10 shows a fourth pattern of elements used to form a fourth three-dimensional scenario (termed “Game of Agent”) on the board;

FIG. 11 shows a fifth pattern of elements used to form a fifth three-dimensional scenario (termed “Game of Inventor”) on the board;

FIG. 12 shows a sixth pattern of elements used to form a sixth three-dimensional scenario (termed “Game of Mrs. President”) on the board;

FIG. 13 shows a seventh pattern of elements used to form a seventh three-dimensional scenario (termed “Game of Mr. President”) on the board; and

FIGS. 14(a) through (g) show examples of permitted movements of playing pieces in portions of a three-dimensional structure of the game board according to an embodiment of the invention.

### DETAILED DESCRIPTION OF THE INVENTION

In the following, a detailed description of embodiments of the board game according to the invention is given. In the examples, a given number of columns and rows on the game board is shown, but it is understood that boards comprising alternative numbers of columns and rows would also fall within the scope of the present invention. Furthermore, the number of players is not restricted to four or two as in the examples shown and the basic concepts of the invention could be embodied with many other numbers of players.

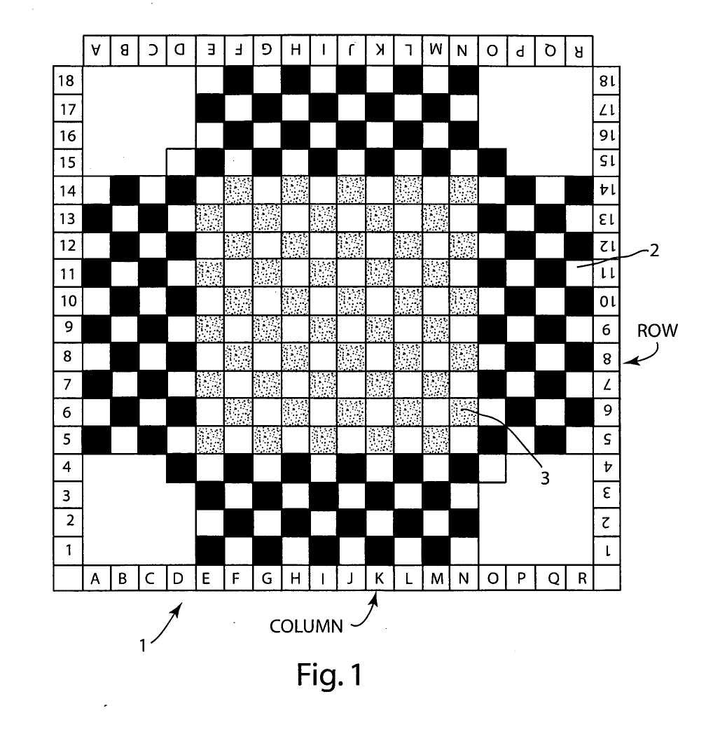

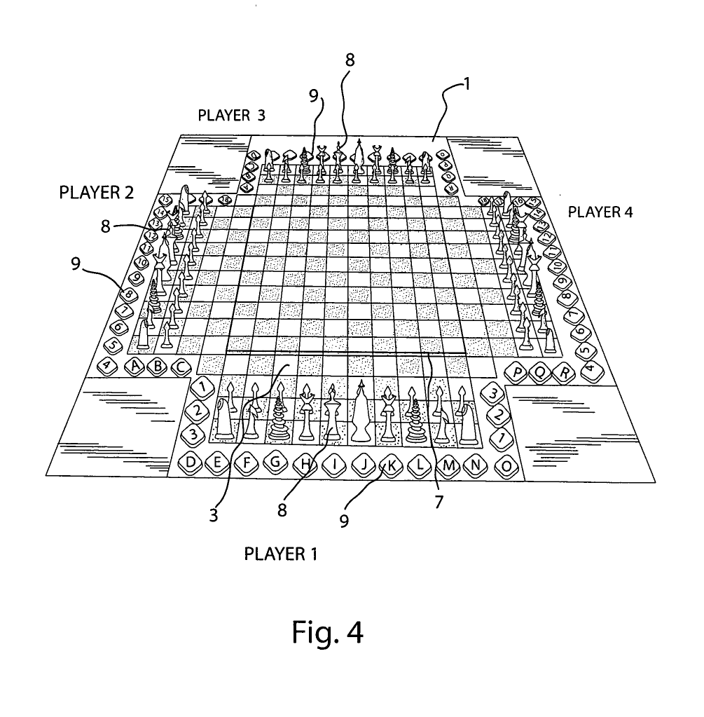

With reference to FIG. 1 there is shown a first embodiment of a game board according to the invention generally designated by reference numeral 1. The board comprises 18 columns designated by letters A, B, C . . . R, respectively, and 18 orthogonally extending rows designated by numbers 1, 2, 3 . . . 18, respectively, these rows and columns defining individual fields as for example designated by reference numeral 2. Adjacent fields are distinguished from each other by the application of different colour, as is well known from chess or checkers. An inner region of fields extending over columns E through N and rows 5 through 14 is distinguished by means of another colour of for instance the darkest of the fields, in the example shown in FIG. 1 indicated by a grey tone and designated by reference numeral 3. Said inner region could alternatively have been highlighted by other means, for instance by elevating the corresponding fields relative to the level of the outermost fields, as shown for instance in FIG. 4. As will be described in connection with FIG. 4, four players can participate in a game using the embodiment shown in FIG. 1.

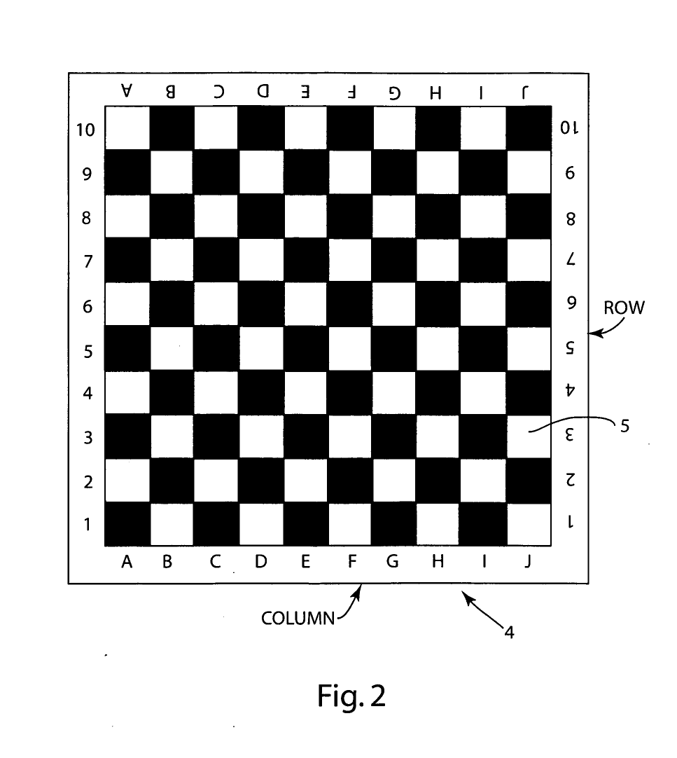

FIG. 2 shows a second embodiment of a game board according to the invention generally designated by reference numeral 4, which is specifically adapted for two players. The board according to this embodiment comprises 10 columns designated by letters A, B, C . . . J, respectively, and 10 rows designated by numbers 1, 2, 3 . . . 10, respectively. These columns and rows define a total of 100 fields, one of these being indicated by reference numeral 5. Different colours may also be used to distinguish adjacent fields in this embodiment.

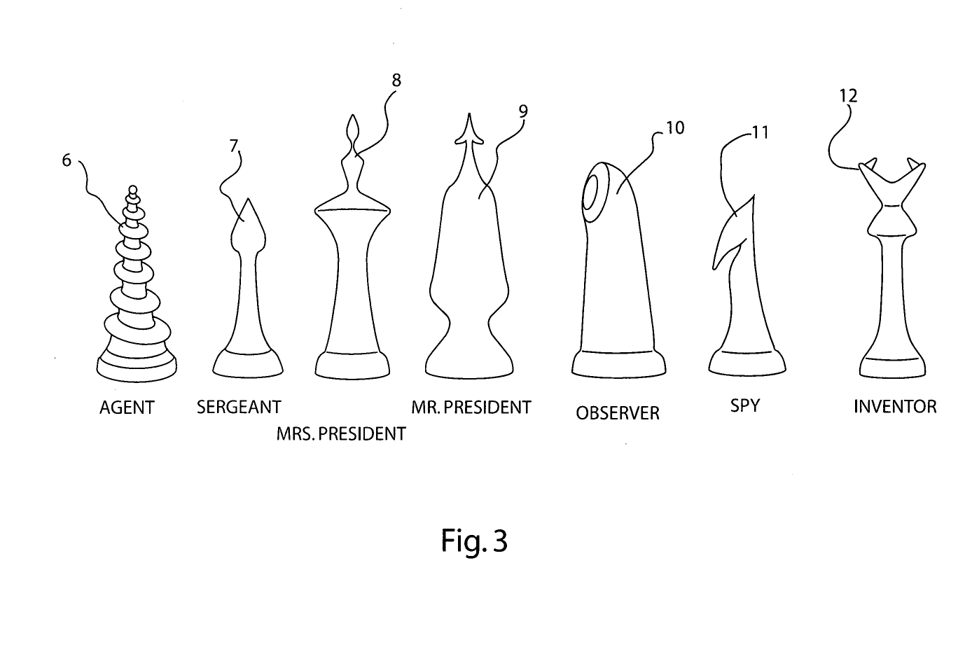

FIG. 3 shows an embodiment of playing pieces according to the invention comprising a total of 7 different playing pieces playing different roles and having different permitted patterns of movement as explained in some detail below. Specifically according to this embodiment, the playing pieces comprise: Agent, 6; Sergeant, 7; Mrs. President, 8; Mr. President, 9; Observer, 10; Spy, 11 and Inventor, 12. A specific design of these playing pieces is shown in FIG. 3, but it is understood that numerous other designs could in principle also have been employed. The playing pieces can be made of any suitable material, for instance wood, a plastics material, glass or metal and the playing pieces can if desired be provided with retainment means for retainment to the playing board or to surfaces of the 3D-members described below in order to retain a piece during movement of the board.

FIG. 4 shows the first embodiment of the game board 1 of the invention with playing pieces (generally indicated by reference numeral 8 in FIG. 4) provided in their initial positions (prior to the commencement of a game) on the board. Four sets of playing pieces, one set for each player, is provided in the two outer rows along each of the four edge portions of the board. In the outermost rows are provided the pieces Observer, Spy, Agent, Inventor, Mr. President, Mrs. President, Inventor, Agent, Spy and Observer in this particular order. In the next row are provided a total of ten Sergeants. As mentioned above the board 1 comprises a central portion 6, which portion in FIG. 1 was distinguished by a separate colour of the darkest fields and which in the embodiment shown in FIG. 4 is distinguished by the central portion 6 being slightly elevated above the level of the outermost portions of the board (where the playing pieces are initially placed) and hence comprising a vertically extending edge portion 7.

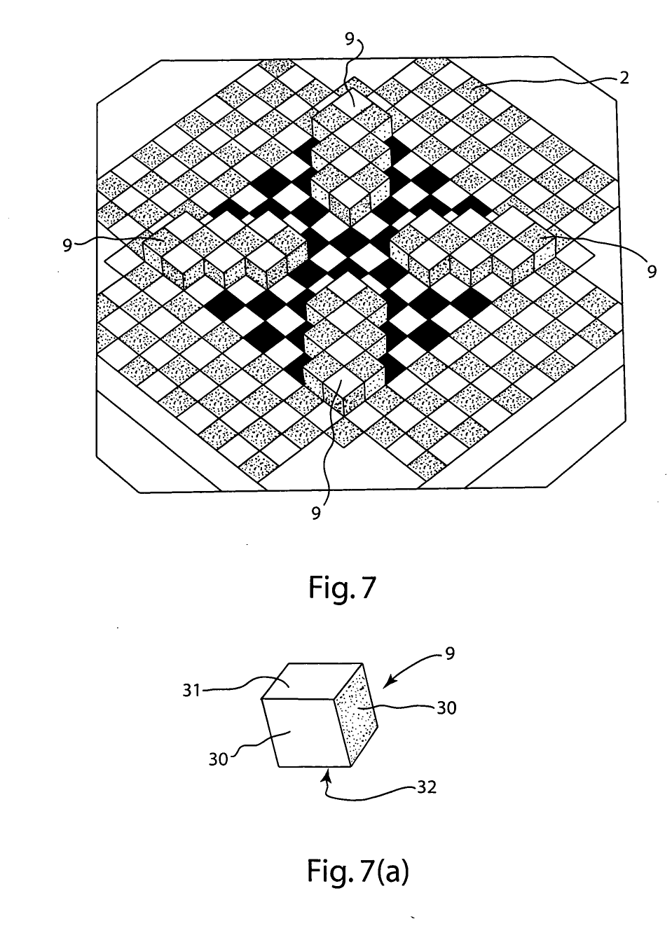

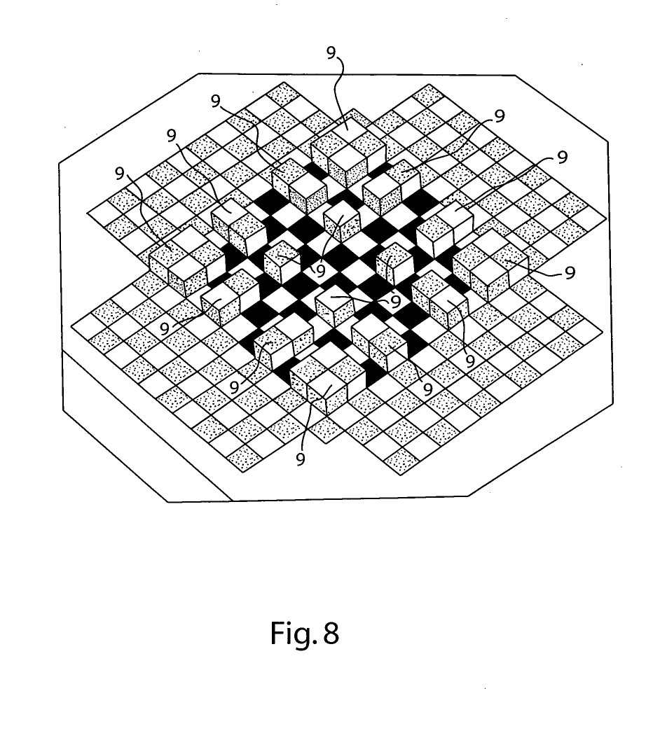

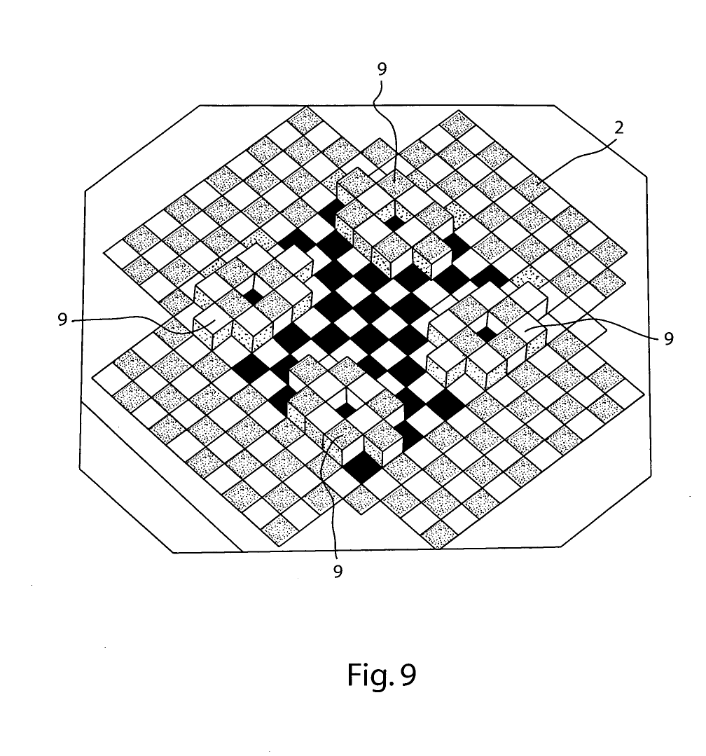

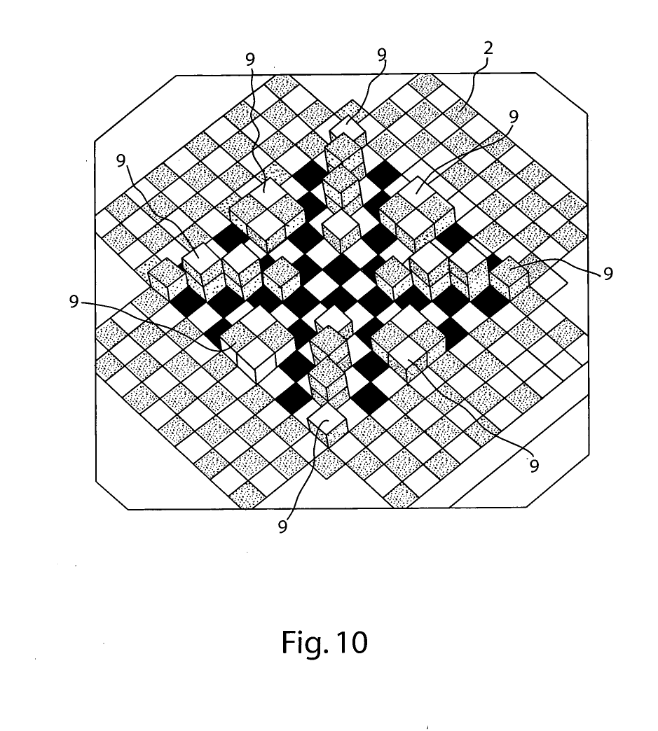

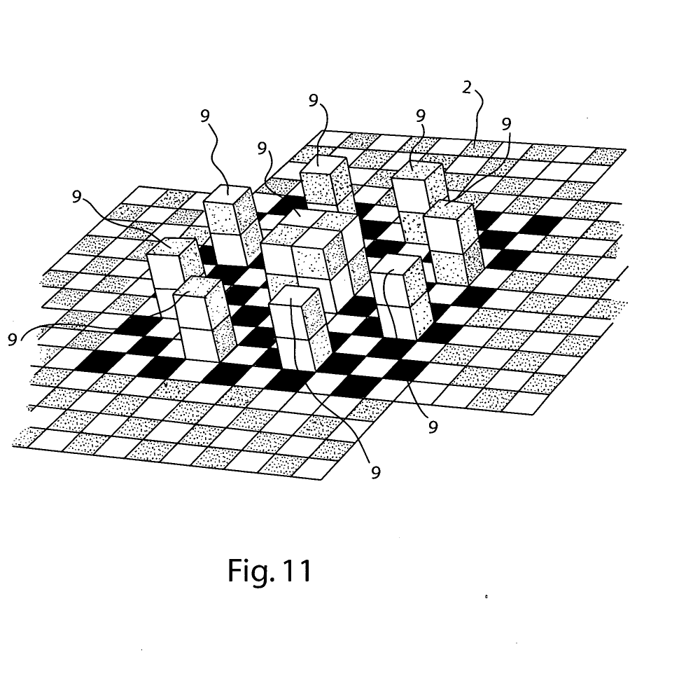

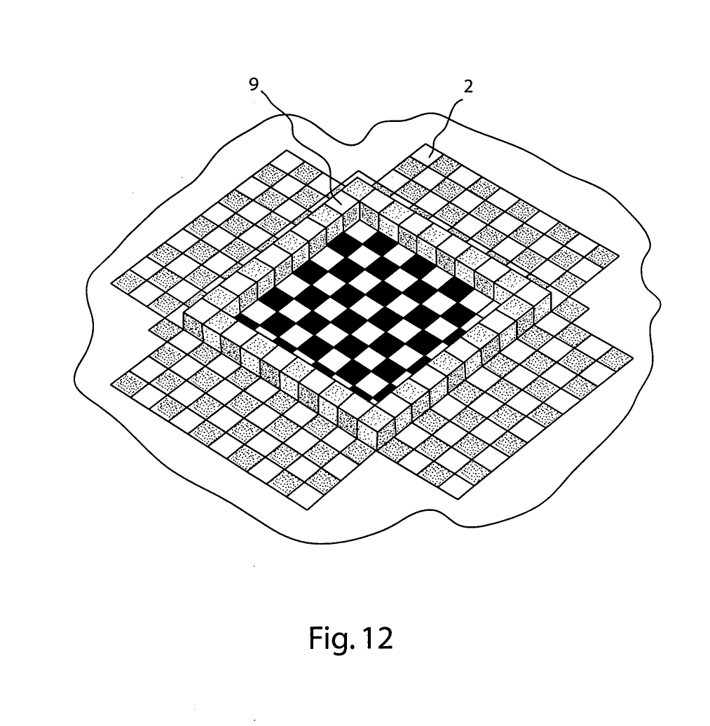

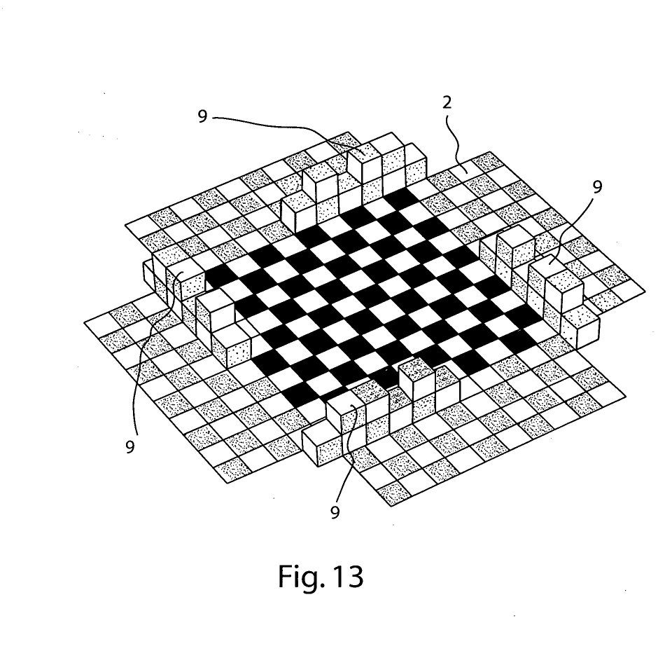

In order to provide the three-dimensional structure of the board as described initially, a number of 3D-members 9 are furthermore initially provided and could for instance be placed along the respective edge portions of the board, each player thus having access to a total of eighteen 3D-members in the embodiment of the invention shown in FIG. 4. Specifically according to this embodiment, the 3D-members are shaped as square boxes, the dimensions of which correspond substantially to the dimensions of each of the fields 3 of the board. The 3D-members according to this embodiment will be described further in connection with FIGS. 7 through 14 below.

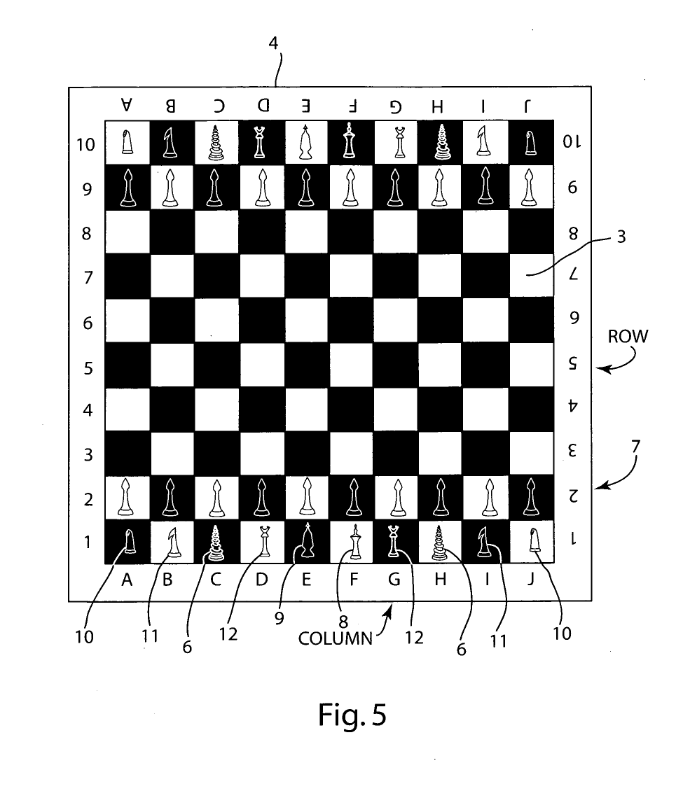

FIG. 5 shows the second embodiment of the game board of the invention described in connection with FIG. 2 with playing pieces 6 through 12 in their initial positions on the board. As indicated, this embodiment is primarily intended for two players.

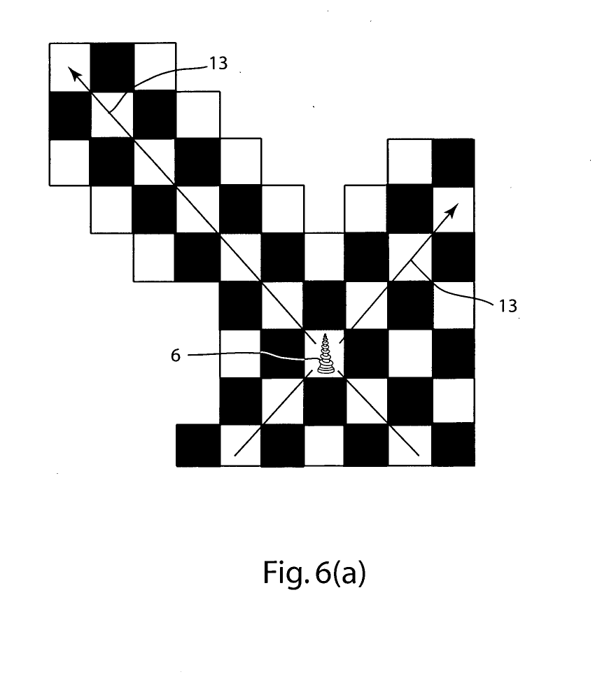

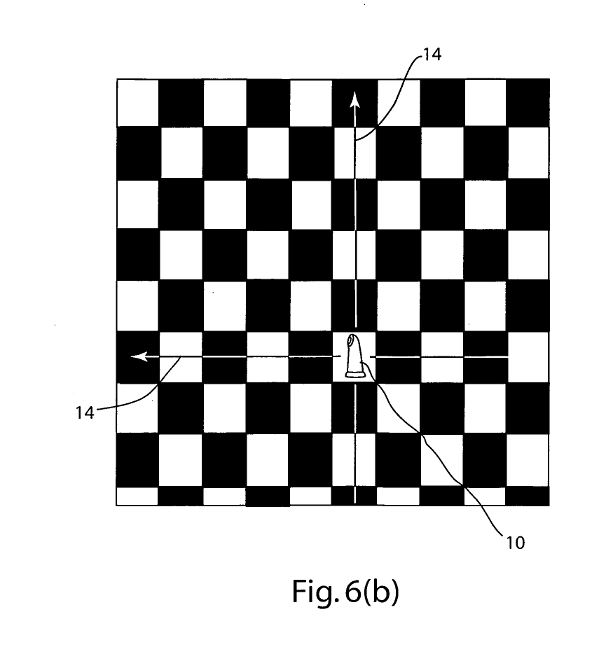

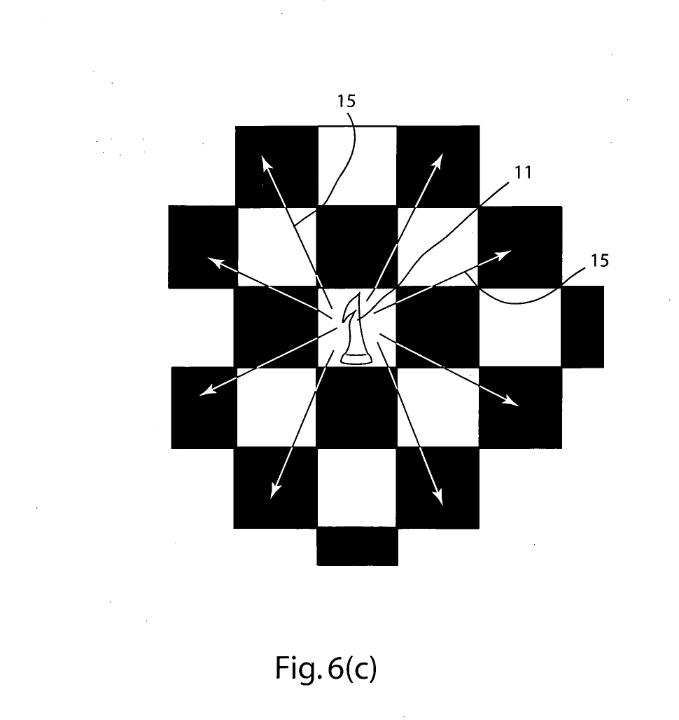

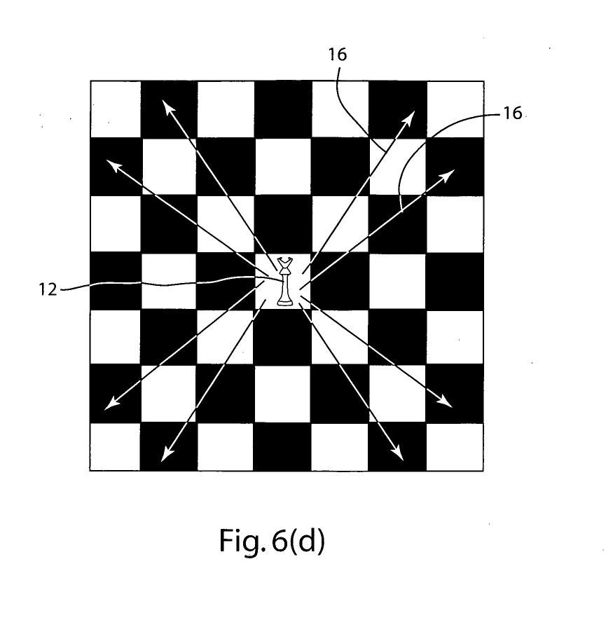

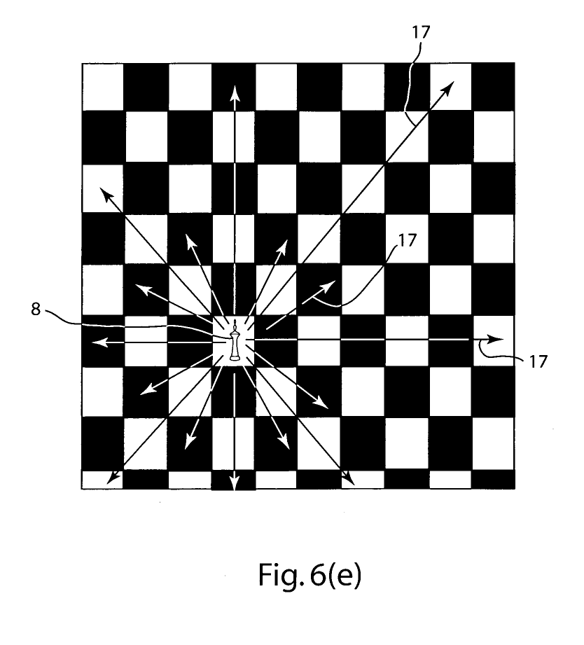

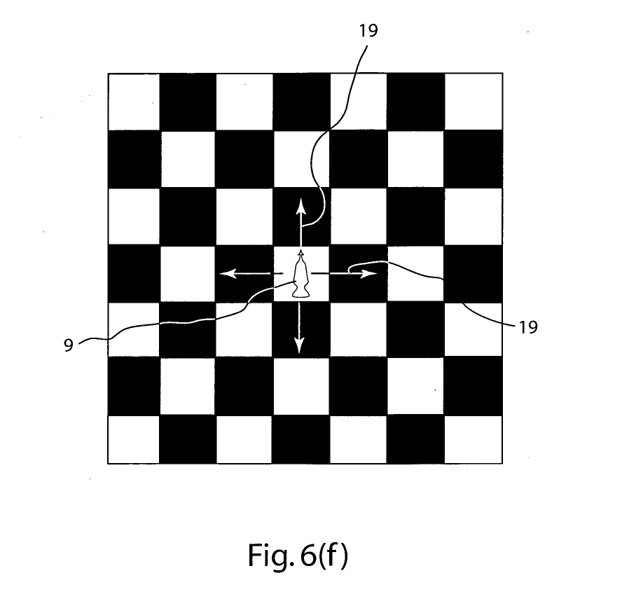

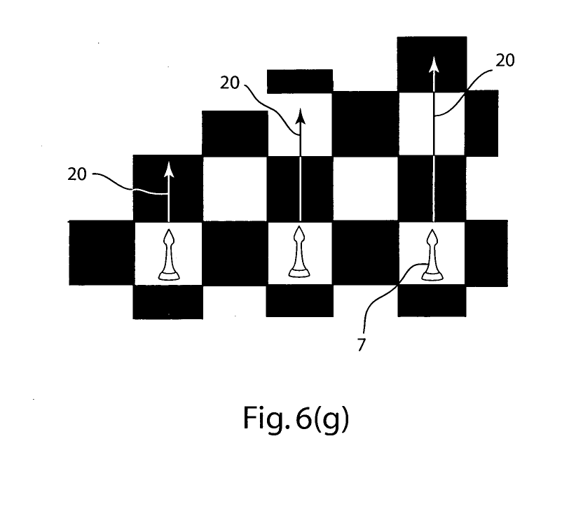

A description of the permitted movements of the different playing pieces will now be briefly given with reference to FIGS. 6 (a)-(g). It is understood that the board game according to the invention could be played using numerous other permitted patterns of movement of the pieces and hence that the shown movements are only to be regarded as examples of permitted movements.

Referring to FIG. 6(a) there is thus shown an example of permitted movements of the “Agent”. The Agent 6 may thus move diagonally over any number of fields as indicated by 13. In FIG. 6(b) is shown an example of permitted movements of the “Observer”. The Observer 10 may thus move in either direction parallel with the rows or with the columns as indicated by 14. FIG. 6(c) shows permitted movements of the “Spy” indicated by 15 (corresponding to the “Horse” of traditional chess). FIG. 6(d) shows permitted movements of the “Inventor” 12 as indicated by 16. FIG. 6(e) shows permitted movements of “Mrs. President” (8) as indicated by 17 and 18. FIG. 6(f) shows permitted movements of “Mr. President 9”, as indicated by 19 and finally are the permitted movements of the “Sergeant” 7 shown in FIG. 6(g).

As mentioned according to the invention, 3D-members can be used to form three-dimensional scenarios or landscapes on a two-dimensional board (for instance for four players as shown in FIG. 1 or for two players as shown in FIG. 2). According to a specific embodiment of the invention, choice is made between different predefined scenarios, i.e. placements of 3D-members on the board and possibly corresponding specific rules in a first game phase, after which the board game as such is carried out using this three-dimensional landscape/specific rules and for instance the playing pieces described above in connection with FIG. 3.

A specific example of a game according to the invention performed in the above manner is given in the following in broad terms. It is understood that only those details, which are considered relevant for understanding the invention, will be given in the following example.

The game according to this example basically comprises said first phase aiming at distributing the 3D-members on the board and said second phase comprising the board game itself.

The game comprises four basic types of game or biddings, each represented by four cards, namely:
1. “Classic”: A landscape without 3D-members, i.e. a classic two-dimensional board.
2. “Obligation”: A choice between seven different fixed three-dimensional landscapes. These landscapes and the corresponding games are termed: “Game of Sergeant”, “Game of Observer”, Game of Spy”, Game of Agent”, Game of Inventor”, Game of Mrs. President” and “Game of President”, respectively.
3. “Horizontal”: One player after the other places a chosen number of 3D-members on the board resulting in a three-dimensional landscape.
4: “Insanius”: Each player writes secretly on a card how many 3D-members (for instance between 1 and 10) he wants to place on the board. A rounded average of 3D-members is then determined, thus in the case of four players choosing 3, 5, 8 and 2 members, respectively, resulting in a number of 5 3D-members, which are then, successively, placed on the board as desired by each player.
   Also secret movements of playing pieces can be included in the game, by for instance the players during two rounds of the game secretly writing a movement of a given playing piece on a card and placing the cards in a stock. After two rounds of the game the contents of the stock is disclosed and the other players know which movement a given player is going to make.
   In this particular kind of game the 3D-members also play an active part in a game, in that they can move and/or hit diagonally (counting for one move) within the central portion 6 of the game board.

A choice between these basic kinds of games can be arrived at in many different ways, which will be apparent to a person skilled in the art. One possibility is that each player initially is provided with eight coins: four green coins for “accepted” and four red coins for “not accepted”. Each player is furthermore provided with four cards, one for each of said basic kinds of games, and each player places the four cards in a series according to his priority, after which each player turns up the first of his cards. If three similar kinds of game turn out to have the same first priority, the corresponding kind of game is chosen. Otherwise the next card of each player is turned, and so on if necessarily until all four cards have been turned. In a dead-end situation a decision can for instance be arrived at by throwing a suitable dice or by other suitable means.

It is understood that the rules outlined in broad terms above are only to be regarded as examples of the manner in which the game apparatus and method according to the invention could be used for playing a game and that numerous alternative sets of rules could also be devised and used in connection with the invention.

In the following FIGS. 7 through 13 there are shown the predetermined three-dimensional landscapes comprised by the game “Obligation” as mentioned above.

Referring to FIG. 7(a) there is shown an embodiment of a 3D-member according to the invention in the form of a square, where the dimensions of the square corresponds to the dimensions of a field on the board. The square, which may be made for instance of wood, a plastics material, glass, metal or any other suitable material, comprises a bottom surface 32 for placement of the square on the surface of the board or on another square, a top surface 31 for placement of either a playing piece or another square and vertically extending side faces 30. As mentioned, the top surface and the side faces play an active role in the game in that according to specific rules of the game they can be regarded as “fields” in the same sense as the fields on the board.

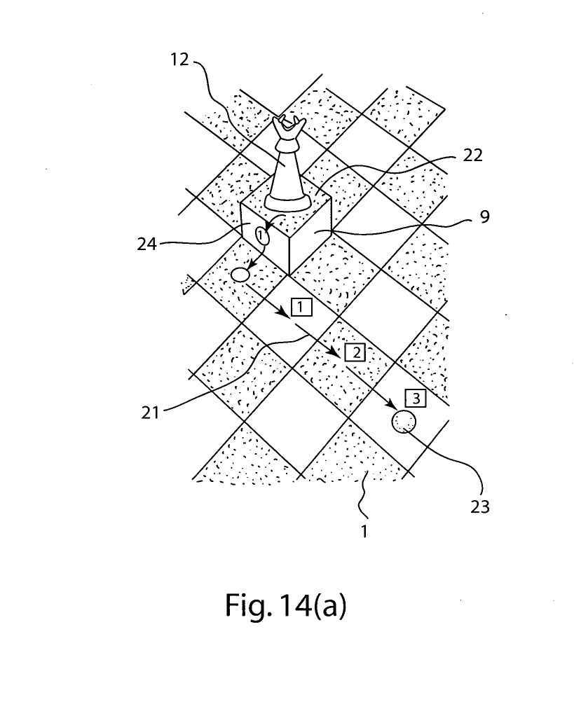

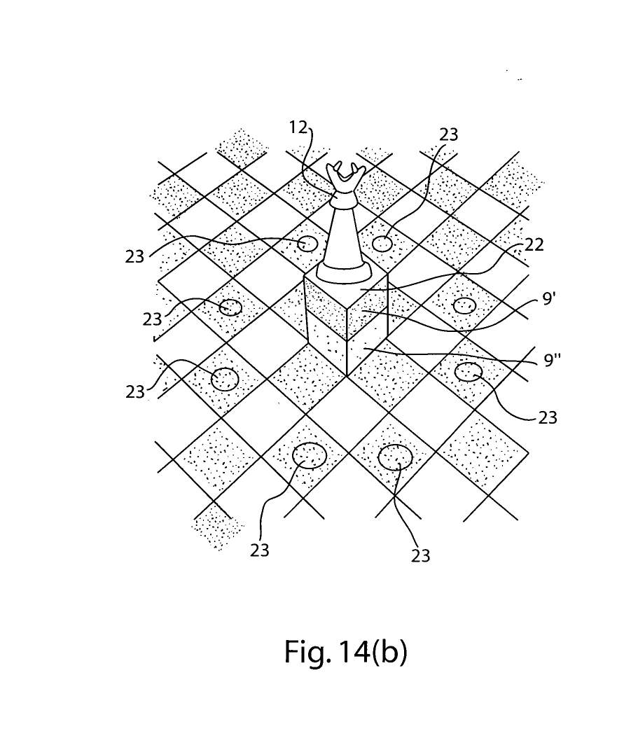

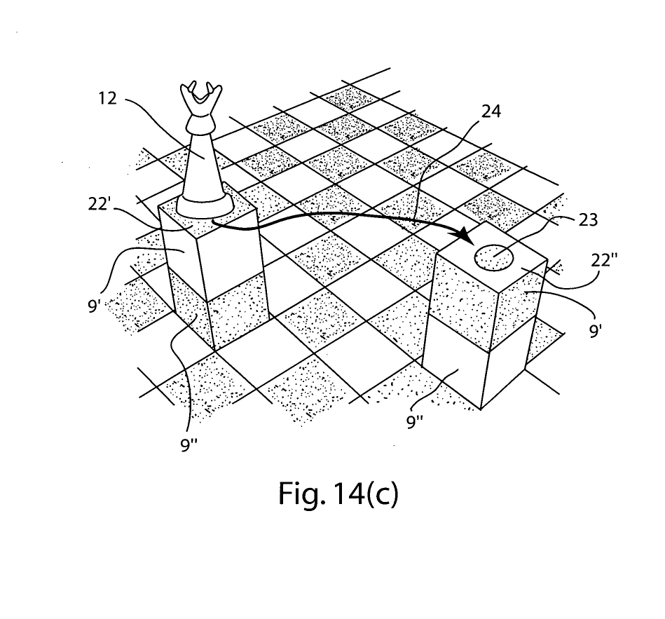

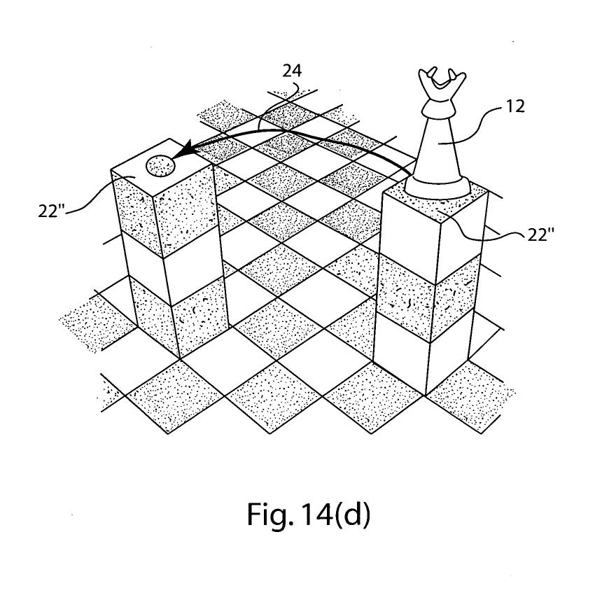

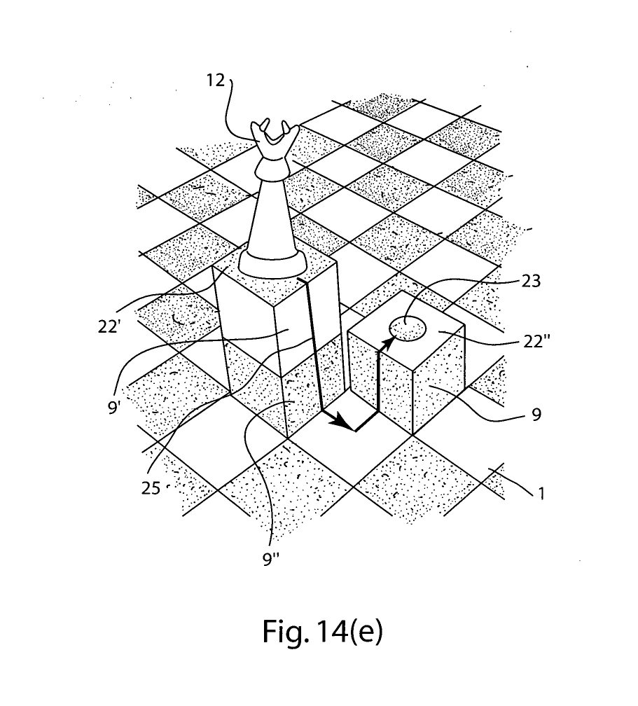

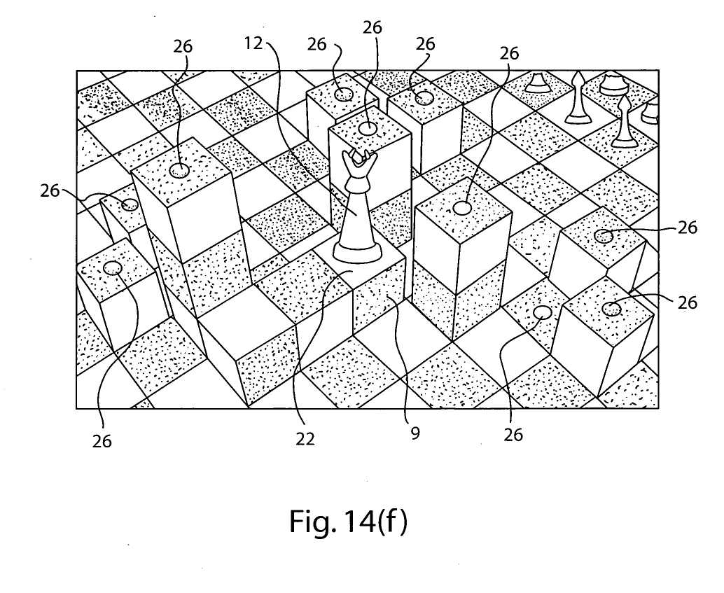

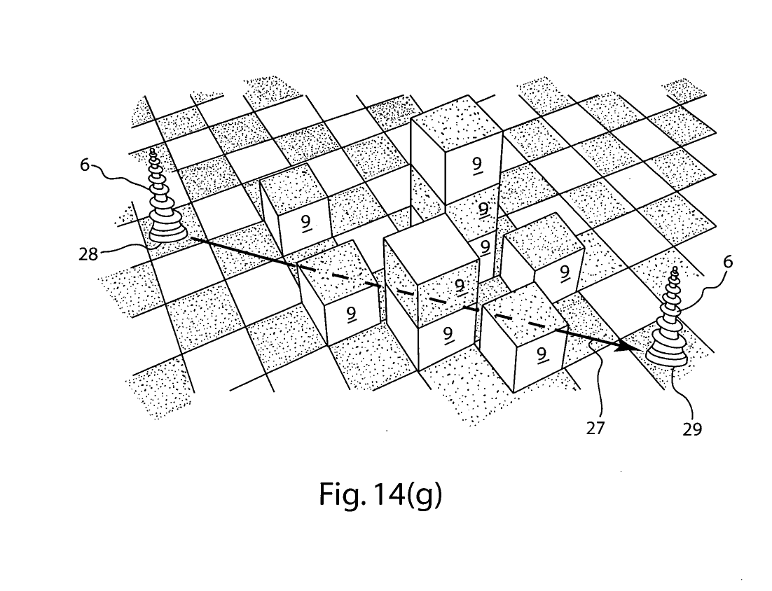

According to the described embodiment of the invention, the 3D-members 9 (FIG. 4) are formed as square blocks dimensioned to fit the dimensions of the fields 2 of the board 1 (or 4). The vertical faces of the blocks thus also correspond in size to the fields 3 of the board 1, 4, and the four vertical faces of the blocks and the top surface of the blocks are in fact to be regarded as additional fields of the game board, thereby affecting the permitted movements of the various playing pieces. Illustrative examples of permitted movements of the playing pieces are given in FIGS. 14(a) through (g).

Referring to FIGS. 7 through 13 the pre-determined placements of 3D-members on the board corresponding to the “landscapes”, viz. “Game of Sergeant”, “Game of Observer”, “Game of Spy”, “Game of Agent”, “Game of Inventor”, “Game of Mrs. President” and “Game of Mr. President” are shown. It is understood that other groupings of 3D-members could have been used alternatively.

Referring to FIG. 14(a) there is as an example shown a permitted movement of the Inventor 12 starting from the top surface 22 of a given 3D-member 9 along a vertical face 24 of the member 9 and horizontally along the board 1 to the final destination 23. All of the other permitted movements of this particular playing piece as described previously could also have taken place starting from the top surface 22 to a given final destination taking the level change from the 3D-member to the surface of the board into account.

Referring to FIG. 14(b) the total number of final destination points 23 of the Inventor 12 is shown, when the Inventor 12 initially is placed on the top surface 22 of the uppermost of two 3D-members 9′, 9″ placed on top of each other.

A special rule is illustrated in FIG. 14(c) where the Inventor 12 is initially placed on the top surface 22′ of two stacked 3D-members 9′, 9″ and moved to the top surface 22″ of two other stacked 3D-members 9′, 9″. In the case where there is no change of level between the initial and final positions of the Inventor, a count of fields is only made in the corresponding plane, i.e. the vertical faces of the 3D-members are not taken into account. This is indicated by the path of movement 24 in FIG. 14(c).

FIG. 14(d) illustrates a corresponding situation where the Inventor moves from the top surface 22′ of the uppermost of three stacked 3D-members to the top surface of the uppermost of three other stacked 3D-members along the path of movement 24, i.e. to a final destination on the same level above the surface of the board as the initial position.

FIG. 14(e) shows movement of the Inventor 12 between different levels above the surface of the board 1. Due to the change of level, the vertical faces 9′ and 9″ of each of the stacked 3D-members and of the single member 9 are taken into account when counting the fields actually passed by the Inventor during movement from the initial position 22′ to the final 22″.

FIG. 14(f) shows a number of permitted final destinations 26 of the Inventor 12 initially placed on the top surface 22 of a 3D-member 9, the surface 22 being located one level above the level of the board. As illustrated both movement upwards and downwards from a given initial level is permitted.

As a final exemplifying illustration of permitted movements, a special rule relating to the Agent 6 is displayed in FIG. 14(g). According to this rule, the Agent 6 can not move to different levels but can instead move diagonally between 3D-members 9, as moving through a gorge between adjacent hills. Thus, the path of movement indicated by 27 between the initial position 28 and the final position 29 is permitted for the Agent 6.

1. A game apparatus for playing a game, comprising
a game board (1, 4) comprising a plurality of rows (R) and a plurality of columns (CO), said rows and columns defining fields (2) on said game board (1, 4);
a plurality of playing pieces (6, 7, 8, 9, 10, 11, 12), one set of playing pieces for each individual player of said game;
a plurality of 3D-members (9) for providing different three-dimensional structures or landscapes on said game board (1, 4), the 3D-members (9) comprising a bottom face (32) for placement on said board or on an adjacent 3D-member, a top surface (22, 31) for placement of an adjacent 3D-member or one of said playing pieces (6, 7, 8, 9, 10, 11, 12) and side faces (30);
characterised in that the height of said side faces (30) corresponding in size to the fields (2) of the board such that during a play said side faces can represent fields (2) that according to specified rules of the game are able to affect permitted movements of said playing pieces (6, 7, 8, 9, 10, 11, 12).

2. A game apparatus according to claim 1, characterised in that said 3D-members (9) are square blocks, the dimensions of which corresponds to the dimensions of the fields (2) on the board (1, 4).

3. A game apparatus according to claim 1, characterised in that it comprises a board (4) with 10 rows (R) and 10 columns (CO) forming 100 fields (2).

4. A game apparatus according to claim 1 characterised in that it comprises a board (1) comprising a maximum of 18 rows (R) and a maximum of 18 columns (CO), the 18 rows corresponding to columns number 5 to 14 (designated by reference letters E to N in FIG. 1) and the 18 columns corresponding to rows number 5 to 14 (designated by reference numbers 5 to 14 in FIG. 1), thereby forming a total and the board (1) having a total of 268 fields (2).

5. A game apparatus according to claim 4, characterised in that the board comprises a central portion (6) of fields (2), the central portion (6) being distinguishable from the remaining portions of the board (1).

6. A method for playing a board game, comprising the following steps:
providing a game board (1, 4) comprising a plurality of rows (R) and a plurality of columns (CO), said rows and columns defining fields (2) on said game board (1, 4);
providing a plurality of playing pieces (6, 7, 8, 9, 10, 11, 12), one set of playing pieces for each individual player of said game;
providing a plurality of 3D-members (9) for providing different three-dimensional structures or landscapes on said game board (1, 4), the 3D-members (9) comprising a bottom face (32) for placement on said board or on an adjacent 3D-member, a top surface (22, 31) for placement of an adjacent 3D-member or one of said playing pieces (6, 7, 8, 9, 10, 11, 12) and side faces (30), where said side faces (30) during a play can represent fields (2) that according to specified rules of the game are able to affect permitted movements of said playing pieces (6, 7, 8, 9, 10, 11, 12);
in a first phase of the game choosing between different types of game (Classic, Obligation, Horizontal, Insanius) to be played, where at least one of said types of game requires the placement of said 3D-members (9) on chosen fields (2) of the game board (1, 4) or on top of other of said 3D-members;
if required according to the type of game chosen, placement of the 3D-members (9) on the game board (1, 4);
performing a board game using said playing pieces (6, 7, 8, 9, 19, 11, 12) and thereby moving said pieces on the board (1, 4) according to predefined rules of the game and under influence of 3D-members placed on the board (1, 4).

7. The method according to claim 6, characterised in that electronic images of the game board, the playing pieces and the 3D-members and other items necessary for performing the game are stored on electronic storage means, whereby an electronic version of the game can be performed electronically via appropriate user interface means manipulating screen images of the game board, the playing pieces and the 3D-members and other items of the game.

8. The method according to claim 7, characterised in that the game is performed remotely via an electronic communication network, such as the Internet.

9. An electronic version of a game stored on an electronic storage medium (hard disk, DVD etc.) controllable according to the method of the game according to claim 6, said game comprising:
a game board (1, 4) comprising a plurality of rows (R) and a plurality of columns (CO), said rows and columns defining fields (2) on said game board (1, 4);
a plurality of playing pieces (6, 7, 8, 9, 10, 11, 12), one set of playing pieces for each individual player of said game;
a plurality of 3D-members (9) for providing different three-dimensional structures or landscapes on said game board (1, 4), the 3D-members (9) comprising a bottom face (32) for placement on said board or on an adjacent 3D-member, a top surface (22, 31) for placement of an adjacent 3D-member or one of said playing pieces (6, 7, 8, 9, 10, 11, 12) and side faces (30);
characterised in that the height of said side faces (30) corresponding in size to the fields (2) of the board such that during a play said side faces can represent fields (2) that according to specified rules of the game are able to affect permitted movements of said playing pieces (6, 7, 8, 9, 10, 11, 12).
